(19) United States
(12) Patent Application Publication
(10) Pub. No.: US 2024/0034621 A1
(43) Pub. Date: Feb. 1, 2024

(54) METHOD AND SYSTEM FOR THE MATERIAL UTILIZATION OF HYDROGEN

(71) Applicant: HYDROGENIOUS LOHC TECHNOLOGIES GMBH, Frlangen (DE)

(72) Inventors: Alexander WEIß, Möhrendorf (DE); Peter DAUNER, Erlangen (DE); Alexander SEIDEL, Erlangen (DE)

(21) Appl. No.: 18/265,297

(22) PCT Filed: Dec. 1, 2021
(86) PCT No.: PCT/EP2021/083713

§ 371 Date: Jun. 5, 2023

(30) Foreign Application Priority Data
Dec. 7, 2020 (DE) 10 2020 215 444.9

(51) Int. Cl. C01B 3/00

(52) U.S. Cl. CPC C01B 3/0015

(57) ABSTRACT

A method for the use of hydrogen as a resource includes producing a mixture by a catalytic reaction in a reactor. The mixture includes hydrogen carrier medium to which hydrogen can be chemically bound by a catalytic hydrogenation reaction and from which hydrogen can be released again by a catalytic dehydrogenation reaction, and hydrogen that is dissolved, i.e. physically stored, therein, and hydrogenating the hydrogen carrier medium with the dissolved hydrogen in a hydrogenation unit.

### CROSS-REFERENCES TO RELATED APPLICATIONS

This application claims the priority of German Patent Application, Serial No. DE 10 2020 215 444.9, filed Dec. 7, 2020, the content of which is incorporated herein by reference in its entirety as if fully set forth herein.

### FIELD OF THE INVENTION

The invention relates to a method and a system for the use of hydrogen as a resource.

### BACKGROUND OF THE INVENTION

A use of hydrogen as a resource is possible, for example, through a catalytic hydrogenation reaction, in which hydrogen gas is chemically bound to a hydrogen carrier medium, or through a catalytic dehydrogenation reaction, in which chemically bound hydrogen is released from a hydrogen carrier medium.

From DE 10 2014 210 464 A1, DE 10 2017 217 748 A1 and DE 10 2018 216 592 A1, respectively, systems are known which comprise a dehydrogenation reactor and a hydrogenation reactor for cyclically dehydrogenating and hydrogenating hydrogen carrier medium, respectively.

DE 10 2014 102 235 A1 discloses a hydrogenation reactor.

Such methods are known from DE 10 2016 222 597 A1 and DE 10 2016 222 596 A1. Due to the solubility of hydrogen in the hydrogen carrier medium, a small amount of hydrogen is dissolved in the hydrogen carrier medium after the hydrogenation reaction or the dehydrogenation reaction, i.e. it is physically stored. The dissolved hydrogen is removed from the hydrogen carrier medium. The removal of the dissolved hydrogen requires additional process steps and system equipment and is therefore complex. The removed hydrogen is lost for further use as a resource or would have to be fed back into the process at great expense, for example by means of a compressor or a similar unit.

### SUMMARY OF THE INVENTION

It is an object of the invention to improve, in particular to simplify, the use of hydrogen as a resource, in particular to increase the economic efficiency of the use of hydrogen as a resource, to optimize a method for the use of hydrogen as a resource and, in particular, to increase the efficiency in the use of hydrogen as a resource.

This object is achieved according to the invention by a method for the use of hydrogen as a resource, comprising the method steps of producing a mixture by means of a catalytic reaction in a reactor, wherein the mixture comprises hydrogen carrier medium to which hydrogen can be chemically bound by a catalytic hydrogenation reaction and from which hydrogen can be released again by a catalytic dehydrogenation reaction, and additionally hydrogen that is dissolved, i.e. physically stored, in the hydrogen carrier medium, and hydrogenation of the hydrogen carrier medium with the dissolved hydrogen in a hydrogenation unit and by a system for the use of hydrogen as a resource, comprising at least one reactor for producing a mixture by means of a catalytic reaction, wherein the mixture comprises hydrogen carrier medium to which hydrogen can be chemically bound by a catalytic hydrogenation reaction and from which hydrogen can be released again by a catalytic dehydrogenation reaction, and additionally hydrogen that is dissolved, i.e. physically stored, in the hydrogen carrier medium, and a hydrogenation unit that is in fluid communication with the reactor for hydrogenating the hydrogen carrier medium with the dissolved hydrogen.

The essence of the invention is that a mixture is produced by means of a catalytic reaction in a reactor, which mixture comprises hydrogen carrier medium and hydrogen that is dissolved therein, in particular hydrogen gas. The hydrogen carrier medium may be at least partially hydrogenated, i.e. charged with hydrogen gas, or at least partially dehydrogenated, i.e. discharged of hydrogen gas. Hydrogen may be chemically bound to the hydrogen carrier medium. In addition, hydrogen gas is dissolved in the hydrogen carrier medium. The hydrogen gas is physically stored on the hydrogen carrier medium. The hydrogen gas that is dissolved in the hydrogen carrier medium is not chemically bound to the hydrogen carrier medium. In particular, the hydrogen carrier medium is a liquid. In particular, hydrogen gas is dissolved in the liquid. In particular, the mixture consists exclusively of the hydrogen carrier medium and the dissolved hydrogen gas. The mixture is fed to a hydrogenation unit. However, the mixture may also have other components, in particular other gases, which are in particular physically stored in the hydrogen carrier medium, in particular hydrocarbon compounds, in particular methane. Such compounds are not suitable for a downstream hydrogenation, but they are also not disturbing. In the hydrogenation unit, the hydrogen carrier medium is hydrogenated with the dissolved hydrogen. In the hydrogenation unit, a so-called post-hydrogenation takes place.

The post-hydrogenation of the hydrogen that is physically dissolved in the hydrogen carrier medium reduces the content of the physically dissolved hydrogen to below the solubility equilibrium. The risk of hydrogen unintentionally outgassing from the hydrogen carrier medium at a later point in time, for example if changed ambient conditions shift the solubility equilibrium to the side of the gaseous hydrogen, in particular due to a cooling and/or in particular due to a pressure relief, in particular in a storage container, is reduced and in particular excluded. The hydrogenation unit is also referred to as a hydrogenation cartridge.

It has been found that the hydrogenation unit can be designed and constructed in a particularly uncomplicated manner, in particular more uncomplicated than a primary hydrogenation reactor.

The construction and/or manufacturing effort for producing the hydrogenation unit is low. In particular, it is not necessary to design the hydrogenation unit in the sense of a classical tube bundle reactor, as is required, for example, for the primary hydrogenation reactor. The hydrogenation unit can be designed in an uncomplicated manner as a high-volume container, in particular with a few, in particular with a maximum of ten, in particular with a maximum of eight, in particular with a maximum of six, in particular with a maximum of four, in particular with a maximum of three, in particular with a maximum of two and in particular with only one single reaction volume. The main function of the container of the hydrogenation unit is the immobilization of a hydrogenation catalyst which can be arranged in the hydrogenation unit, i.e. in particular its targeted and defined arrangement.

In particular, a housing of the hydrogenation unit can be designed to optimize space requirements. For the design of the container of the hydrogenation unit, extended design possibilities and constructive flexibilities result.

The fact that the hydrogenation unit can be designed in a geometrically uncomplicated manner is based on the finding according to the invention that a comparatively small amount of heat is required for hydrogenating the physically stored hydrogen in the hydrogenation unit. A separate cooling of the hydrogenation unit by means of a separate cooling unit is not costly or labor-intensive and can in particular be omitted. A cooling unit that is required for the hydrogenation unit can be of small dimensions, i.e. designed with a low cooling capacity. In particular, it has been found that such a cooling unit can be dispensed with altogether. It has been found that a heat input induced into the hydrogen carrier medium as a result of the exotherm by the hydrogenation in the hydrogenation unit would lead to at most a small temperature increase, in particular by less than 20° C., in particular less than 15° C. and in particular less than 10° C. Such a heating of the hydrogen carrier medium is not critical and can be tolerated.

The reason for the comparatively low amount of heat in the hydrogenation unit results from the comparatively low hydrogenation conversion in the hydrogenation unit. Since the hydrogen carrier medium comprises a comparatively low saturation limit for the physically stored hydrogen, the amount of hydrogen that can be converted in the hydrogenation unit is limited. For example, the saturation limit for hydrogen gas in the hydrogen carrier medium is between 0.001 wt. % to 0.06 wt. %, in particular between 0.0015 wt. % and 0.055 wt. % and in particular between 0.002 wt. % and 0.05 wt. %. It has further been found that the saturation limit is in particular pressure-dependent and/or in particular temperature-dependent. In particular, it has been found that higher saturation limits of the hydrogen in the hydrogen carrier medium can be achieved at a constant temperature and in particular at higher pressures. In particular, it has been found that the saturation limit can also depend on the hydrogen carrier medium used in each case. For example, the hydrogen carrier medium in the form of dibenzyltoluene has a comparatively lower hydrogen solubility than benzyltoluene.

In contrast to the hydrogenation unit, a cooling unit, especially one with large dimensions, is advantageous for the primary hydrogenation reactor.

The hydrogenation unit is thus particularly suitable for a flexible application and/or in particular for an independent arrangement in a system, in particular before cooling and/or pressure relief.

The hydrogenation unit is particularly suitable for use in a region of the system where high temperatures prevail, in particular adjacent to a primary hydrogenation reactor and/or at a primary dehydrogenation reactor and in particular integrated in the primary hydrogenation reactor or primary dehydrogenation reactor.

It is also possible to arrange several hydrogenation units, especially sequentially, i.e. one after the other in a system for the use of hydrogen as a resource.

Surprisingly, it has been found that by using the dissolved hydrogen for hydrogenating the hydrogen carrier medium, the effort for removing the dissolved hydrogen is reduced and in particular avoided. This increases the efficiency of the method, in particular for the use of hydrogen as a resource. Furthermore, it has been recognized that the hydrogen removed according to the prior art remains unused. By using the dissolved hydrogen for hydrogenating the hydrogen carrier medium, there is an increased efficiency in the use of hydrogen as a resource. Investigations by the applicant have shown that the proportion of physically dissolved hydrogen can be between 0.002 wt. % and 0.05 wt. % relative to the mass of the hydrogen carrier medium, depending on the reaction conditions of the catalytic reaction. The utilization of the hydrogen in the use as a resource is increased. In particular, there is a savings potential with respect to the hydrogen consumption due to the post-hydrogenation according to the invention.

Furthermore, it has been found that dissolved hydrogen in the hydrogen carrier medium can cause malfunctions and/or unintended safety shutdowns of the system during operation. By hydrogenating with the dissolved hydrogen according to the invention, disturbances during the operation of the system are avoided. The safety of the system is increased.

The hydrogen carrier medium is in particular an organic hydrogen carrier liquid (LOHC). The hydrogen carrier medium can be reversibly charged and discharged with and of hydrogen by means of catalytic hydrogenation and dehydrogenation reactions.

The hydrogen carrier medium comprises in particular dibenzyltoluene, benzyltoluene and/or toluene, as well as their hydrogenated compounds perhydrodibenzyltoluene, perhydrobenzyltoluene and/or methylcyclohexane.

According to the invention, it has been recognized that a downstream hydrogenation is possible without having to supply additional, i.e. separate hydrogen. Instead, the hydrogen that is dissolved in the hydrogen carrier medium can be used directly.

In particular, according to the invention, it is avoided that gas bubbles form from the dissolved hydrogen, which can lead to malfunctions, in particular in pumps and/or measuring instruments.

In particular, it is possible to use the reaction conditions in the upstream catalytic reactor for the downstream hydrogenation in the hydrogenation unit, in particular without major apparatus and/or process engineering effort, in particular without active cooling of the hydrogen carrier medium and in particular without upstream recuperation if the catalytic reaction is a hydrogenation reaction. It is possible that the hydrogenation unit is actively cooled during post-hydrogenation due to the reaction exotherm.

If the catalytic reaction is a dehydrogenation reaction, it is advantageous to actively cool the hydrogen carrier medium, in particular to arrange the hydrogenation unit downstream of a cooling unit and/or a recuperation unit.

According to the invention, a more efficient use of hydrogen results from a higher charging of the hydrogen carrier medium which serves as a hydrogenation product and/or a hydrogenation reduct. According to the invention, a hydrogen cycle is created, in particular within a hydrogenation and/or dehydrogenation process, without the need for removal of the hydrogen. Due to the reduction of gaseous hydrogen, the storage and/or the transport of the hydrogen carrier medium are additionally improved, in particular only made possible under safety-relevant aspects. It has been recognized that the transport of hazardous materials is problematic and can be prohibited in particular if hydrogen gas may outgas from the hazardous materials. By removing physically dissolved hydrogen from the hydrogen carrier medium, the hydrogen carrier medium is improved, in particular with regard to transport and logistics. Liquid transport of the hydrogen carrier medium in tank containers and/or tank vehicles is not problematic in terms of safety.

In particular, it has been found that safety with regard to transport and/or logistics of the hydrogen carrier medium is increased if the hydrogenation cartridge is integrated in a storage container of the hydrogen carrier medium, in a tank container and/or a tank vehicle for transporting the hydrogen carrier medium. Surprisingly, the applicant has found that the post-hydrogenation of outgassing hydrogen gas using a hydrogenation catalyst is possible at ambient temperature, in particular at a temperature of in particular at most 40° C., in particular at most 35° C., in particular at most 30° C., in particular at most 25° C. and in particular at most 20° C., and/or at a low overpressure of in particular at most 0.8 barg, in particular at most 0.7 barg, in particular at most 0.6 barg, in particular at most 0.55 barg and in particular at most 0.5 barg. Although the reaction conditions for the post-hydrogenation of outgassing hydrogen have a comparatively low reaction rate and are reduced with regard to the reaction rate, in particular with a hydrogenation reaction in a primary hydrogenation reactor, the safety during storage and/or transport of the hydrogen carrier medium is additionally increased. In particular, the risk of hydrogen outgassing due to creeping equilibrium changes is reduced. Particularly advantageous is the integration of the hydrogenation cartridge in the storage container, the tank container and/or the tank vehicle, in which at least partially discharged hydrogen carrier medium is stored and/or transported.

The hydrogenation catalyst that is used in the hydrogenation cartridge that is integrated in the storage container, the tank container and/or the tank vehicle may differ from the catalyst that is used in the other hydrogenation cartridges and/or from the catalyst used in the primary hydrogenation reactor. It may be advantageous to provide a different catalyst material, catalyst quantity and/or catalyst mixture to enable post-hydrogenation at the reduced temperatures and overpressure.

The integration of the hydrogenation unit in the storage container, the tank container and/or the tank vehicle is suitable for the post-hydrogenation of previously hydrogenated or dehydrogenated hydrogen carrier medium, i.e. of at least partially charged and at least discharged hydrogen carrier medium.

According to the invention, it has been recognized that the use of physically dissolved hydrogen, which has so far been rejected according to the prior art, enables a higher economic efficiency of the method or the systems, moreover, the systems can be operated in an optimized manner in terms of process technology and, finally, an increased efficiency in the overall process related to the hydrogen carrier medium is possible. The fact that physically dissolved hydrogen is used for post-hydrogenation improves the overall safety of the systems and the logistics of the hydrogen carrier medium.

Calculations by the applicant have shown that a system which has a storage capacity of 5t of hydrogen gas per day wastes, i.e. does not use, about 35 kg of hydrogen per day in conventional operation according to the prior art. Based on a purchase price of currently about 1.50 €/kg to 4.00 €/kg of hydrogen gas, this results in a cost potential of about EUR 20,000.00 to EUR 50,000.00 per year, assuming that the system runs in continuous operation. These costs can be saved according to the invention. Mathematically, the cost saving potential is even greater if it is considered that in dehydrogenation operation, i.e. when the reactor is a primary dehydrogenation reactor, hydrogen gas is produced which can be traded as product hydrogen at an increased sales price, for example at a hydrogen filling station. The sales price is a multiple of the purchase price.

Furthermore, the hydrogen input during hydrogenation is reduced if physically dissolved hydrogen is used for post-hydrogenation of the hydrogen carrier medium following dehydrogenation.

As a result, the hydrogen carrier medium, which is returned to the hydrogen carrier medium cycle, which is to be seen in particular globally, is comparatively less discharged. The effort, in particular the hydrogen input, that has to be expended for recharging is reduced.

In a method in which the hydrogenation in the hydrogenation unit takes place by means of a hydrogenation catalyst, the efficiency of hydrogenation in the hydrogenation unit is increased. A hydrogenation catalyst in the hydrogenation unit is in particular identical to a hydrogenation catalyst used for a hydrogenation reaction in an upstream primary hydrogenation reactor. However, the hydrogenation catalyst in the hydrogenation unit may also be individually adapted to the reaction conditions in the hydrogenation unit and may in particular differ from the hydrogenation catalyst in the primary hydrogenation reactor. The hydrogenation catalyst in the hydrogenation unit is in particular a metal, which may be present as a supported metal, metal oxide, metal hydride and/or metal hydroxide. The catalyst comprises in particular platinum, ruthenium, palladium, iridium, gold, silver, rhenium, rhodium, copper, nickel, cobalt, iron, manganese, chromium, molybdenum and/or vanadium. Mixed metal hydrogenation catalysts and/or bimetallic hydrogenation catalysts comprising platinum and palladium have proven to be particularly advantageous, in particular in elemental form and/or in oxide form. The hydrogenation catalyst is present as a supported metal/alumina catalyst, wherein platinum and palladium can be the mixed metals.

In a method in which the hydrogenation takes place in the hydrogenation unit before the mixture from the reactor is depressurized, in particular in a pressure regulation unit, substantially complete and in particular complete hydrogenation of the physically dissolved hydrogen is possible.

It has been found that the thermodynamic conditions of the mixture in the reactor, in particular its pressure and temperature, are particularly advantageous for hydrogenation in the hydrogenation unit. In particular, the mixture in the hydrogenation unit has a temperature between 100° C. and 300° C., in particular between 150° C. and 250° C., and a pressure in the range from 10 barg to 50 barg and in particular from 20 barg to 30 barg. In particular, the system comprises a pressure regulation unit in which the mixture from the reactor is depressurized, i.e. the pressure of the mixture is reduced. It is advantageous if hydrogenation takes place in the hydrogenation unit before the mixture is fed to the pressure regulation unit for pressure relief.

It is particularly advantageous if the hydrogen carrier medium in the mixture, in particular when entering the hydrogenation unit, has a maximum hydrogenation degree of at most 99%. It is then possible to hydrogenate the hydrogen carrier medium completely, i.e. up to a hydrogenation degree of 100%. However, it may also be advantageous to have a lower degree of hydrogenation upon entry into the hydrogenation unit, in particular at least 90%, in particular at least 92%, in particular at least 94%, in particular at least 95% and in particular at least 96%. It is then possible to hydrogenate the hydrogen carrier medium to a target hydrogenation degree of at least 97%. In this case, the method is particularly economical. It should be considered that in principle a comparatively low input hydrogenation degree is advantageous for the hydrogenation rate. A pressure relief of the mixture, i.e. a reduction of the pressure, can take place in a pressure regulation unit, in particular downstream of the hydrogenation unit.

It has been found that complete hydrogenation of the physically dissolved hydrogen is possible with a small amount of catalyst relative to the catalyst in the reactor. In particular, an amount of the hydrogenation catalyst in the hydrogenation unit in a range between 1% and 5%, in particular of at most 3%, in particular at most 2%, in particular at most 1.5% and in particular at most 1% relative to the amount of catalyst in the reactor is sufficient if the reactor is a primary hydrogenation reactor. If the reactor is a primary dehydrogenation reactor, complete hydrogenation of the dissolved hydrogen in the hydrogenation unit can take place at a reduced catalyst amount due to the comparatively lower amount of dissolved hydrogen. In this case, a catalyst amount in the hydrogenation unit of between 0.1% to 3%, in particular of at most 0.5%, in particular at most 0.3%, in particular at most 0.2% and in particular at most 0.1% relative to the catalyst amount in the primary dehydrogenation reactor is sufficient.

A method in which the mixture is produced by hydrogenating the hydrogen carrier medium in a primary hydrogenation reactor that is located upstream of the hydrogenation unit enables efficient post-hydrogenation after a hydrogenation reaction in a primary hydrogenation reactor. The hydrogenation in the primary hydrogenation reactor is carried out in particular by means of separately supplied hydrogen gas. In particular, a primary hydrogenation catalyst is arranged in the primary hydrogenation reactor, which primary hydrogenation catalyst is in particular identical to the hydrogenation catalyst in the hydrogenation unit. However, the hydrogenation catalysts in the primary hydrogenation reactor and in the hydrogenation unit may also be different. The hydrogenation reaction in the primary hydrogenation reactor chemically binds the hydrogen gas to the hydrogen carrier material.

It has been found that it is advantageous if the post-hydrogenation takes place in the hydrogenation unit before the hydrogen carrier medium with the dissolved hydrogen is fed to a heat exchanger and/or a pressure relief stage. In particular, the hydrogenation unit is arranged upstream of a heat exchanger and/or a pressure relief stage in such a system. In particular, it has been found that it is advantageous if the hydrogenation unit is arranged downstream of the primary hydrogenation reactor and, in particular, is connected to a pipeline that is connected to the primary hydrogenation reactor and is connected to the primary hydrogenation reactor, in particular directly, via this pipeline. It has been found that post-hydrogenation can be advantageously carried out at high pressure and/or high temperatures with such positioning, in particular if subsequent contact with the hydrogen gas phase is avoided in order not to re-saturate the liquid phase of the hydrogen carrier medium with dissolved hydrogen.

In addition or alternatively, the hydrogenation unit can be placed in a region of the system in which the dwell time of the hydrogen carrier medium is large and in particular very large, in particular in storage containers and/or in a transport vehicle. Advantageous post-hydrogenation is also possible in the storage container and/or the transport vehicle, in particular, when the pressure and/or temperature are comparatively low and, in particular, the concentration of physically stored hydrogen is small. This is because the hydrogenation rate can be compensated for over the dwell time of the hydrogen carrier medium by slowly post-hydrogenating hydrogen gas from the liquid phase of the hydrogen carrier medium.

In a method in which the hydrogenation takes place in the hydrogenation unit before the mixture from the reactor is cooled, in particular in a heat exchanger, the proportion of dissolved hydrogen in the mixture is reduced to at most 50%, in particular at most 45% and in particular at most 40% relative to the maximum soluble hydrogen proportion in the mixture. It has been found that the proportion of dissolved hydrogen that is usable for hydrogenation is comparatively high before a cooling of the mixture in a heat exchanger and in particular before pressure relief. The cooling of the mixture in the heat exchanger takes place by extracting heat from the mixture. This has the effect of reducing the temperature of the mixture to at most 60° C., in particular at most 55° C. and in particular at most 50° C.

A method in which the mixture is produced by dehydrogenating the hydrogen carrier medium in a primary dehydrogenation reactor that is located upstream of the hydrogenation unit enables dehydrogenation in a primary dehydrogenation reactor that is located upstream of the hydrogenation unit. In the primary dehydrogenation reactor, in particular chemically bound hydrogen is released from the hydrogen carrier medium and, in particular, discharged separately from the primary dehydrogenation reactor. Alternatively, it is possible to discharge the released hydrogen and the at least partially dehydrogenated hydrogen carrier medium together from the primary dehydrogenation reactor and to separate them from each other in a downstream separation apparatus, in particular in a condenser. In particular, a primary dehydrogenation catalyst is arranged in the primary dehydrogenation reactor. The primary dehydrogenation catalyst is in particular a catalyst material comprising platinum, palladium, nickel, rhodium and/or ruthenium. The catalyst material is in particular arranged on a catalyst carrier and in particular attached thereto. The catalyst carrier is in particular aluminum oxide, silicon oxide, silicon carbide and/or activated carbon. The catalyst carrier is in particular inert. The proportion by weight of the primary dehydrogenation catalyst in relation to the catalyst carrier is between 0.1% and 10%.

In principle, it must be considered that in a system having a primary dehydrogenation reactor, the hydrogen pressure is comparatively low and therefore, in particular, the general gas solubility is lower than in a system having a primary hydrogenation reactor. It is therefore particularly advantageous to arrange the hydrogenation unit in storage containers and/or tank vehicles in order to enable advantageous post-hydrogenation at a comparatively low hydrogenation rate with high dwell times.

It is particularly advantageous if the hydrogenation unit is arranged downstream of a condenser unit. Downstream of the condenser unit, the proportion of the liquid phase of the hydrogen carrier medium is increased and is in particular at least 80%, in particular at least 90%, in particular at least 95%, in particular at least 98% and in particular 100%. Vaporous portions of the hydrogen carrier medium are then no longer present. The risk of undesirable mixing and/or saturation of hydrogen gas with the hydrogen carrier medium is reduced and in particular excluded.

In addition, the arrangement of the hydrogenation unit downstream of the primary dehydrogenation reactor is advantageous where an equilibrium position exceeds the actual degree of hydrogenation of the hydrogen carrier medium due to a temperature drop, so that a hydrogenation reaction proceeds in a favored manner compared to a dehydrogenation reaction, i.e. the post-hydrogenation in the hydrogenation unit proceeds in a favored manner compared to the dehydrogenation in the primary hydrogenation reactor due to the chemical equilibrium. In this case, it is advantageous if the hydrogenation unit is arranged downstream of a condenser unit and/or a recuperation unit and/or downstream of a cooling unit. It has been found that post-hydrogenation does not cause a significant increase in the hydrogenation degree of the hydrogen carrier medium. In particular, the increase in the degree of hydrogenation is less than 2 percentage points, in particular less than 1.5 percentage points, in particular less than 1.0 percentage points, in particular less than 0.8 percentage points and in particular less than 0.5 percentage points. It has been further found that despite the comparatively low pressure of the hydrogen carrier medium downstream of the primary dehydrogenation reactor, the hydrogenation rate during post-hydrogenation in the hydrogenation unit can be raised via an increased temperature.

In addition, it is advantageous if the hydrogenation unit is arranged upstream of a pressure relief, i.e. the post-hydrogenation takes place prior to a pressure relief.

In particular, in a method in which the mixture takes place by dehydrogenation in the primary dehydrogenation reactor, first recuperation, then cooling and/or condensation and then pressure relief are carried out, wherein the post-hydrogenation takes place in particular between the condensation and the pressure relief.

A circulation process, wherein hydrogenation of the hydrogen carrier medium with the physically dissolved hydrogen takes place in the hydrogenation unit in each case between the hydrogenation in the primary hydrogenation reactor and the dehydrogenation in the primary dehydrogenation reactor, has proven to be particularly advantageous. In particular, hydrogenation of the hydrogen carrier medium takes place alternately in a primary hydrogenation reactor and dehydrogenation of the hydrogen carrier medium in a primary dehydrogenation reactor, wherein hydrogenation of the hydrogen carrier medium with the dissolved hydrogen takes place in the hydrogenation unit in each case downstream. In a simplest embodiment, the primary hydrogenation reactor and the primary dehydrogenation reactor are connected by means of a single, bidirectional connection line along which the hydrogenation unit is arranged. This means that a single hydrogenation unit is sufficient, which is arranged between the two primary reactors and which is directly connected to the primary reactors via the single connection line.

It is also conceivable that the reactors are connected to a first connection line in order to convey at least partially charged hydrogen carrier medium from the primary hydrogenation reactor to the primary dehydrogenation reactor. In addition, a second connection line may be provided to convey at least partially discharged hydrogen carrier medium from the primary dehydrogenation reactor into the primary hydrogenation reactor. At least one hydrogenation unit can be arranged along each of the first and second connection lines.

It is particularly advantageous if the primary hydrogenation reactor with downstream hydrogenation unit is arranged at a first location. The primary dehydrogenation reactor can be arranged with a downstream hydrogenation unit at a second location, which is arranged in particular remotely, in particular far away, in particular several 10, several 100 or several 1,000 kilometers away from the first location.

In particular, the primary hydrogenation reactor with the downstream hydrogenation unit and the primary dehydrogenation reactor with the downstream hydrogenation unit form a global closed loop process. It has been recognized that by means of the respective downstream hydrogenation units, physically dissolved hydrogen can be used efficiently in both hydrogenation and dehydrogenation. As a result, the hydrogen gas balance for the global cycle of the hydrogen carrier medium is improved, in particular more efficient. In particular, it has been recognized that hydrogenation in the hydrogenation unit that is located downstream of the dehydrogenation is also advantageous, since less hydrogen needs to be used in a subsequent planned hydrogenation of the discharged hydrogen carrier medium. This results in particular in a more efficient and in particular more cost-effective charging throughout the entire cycle of the hydrogen carrier medium.

The first location and the second location are fluidically connected to each other for the exchange of hydrogenated and dehydrogenated hydrogen carrier medium. This means that the first location and the second location can, for example, be connected to a, in particular, regional, supraregional, national and/or international pipeline network. In addition or alternatively, the fluidic connection is possible by means of transport vehicles, such as tank vehicles, in particular lorries, trains and/or ships.

Alternatively, instead of a primary hydrogenation reactor and a primary dehydrogenation reactor, it is possible to use only one primary reactor in which both the hydrogenation and the dehydrogenation are carried out in a staggered manner, in particular alternately. The system expenditure, in particular the investment costs, are thus reduced. Such a reactor is known from DE 10 2014 223 426 A1. Depending on the energy requirement and/or hydrogen gas storage potential, the reactor can be used for hydrogenation or dehydrogenation of the hydrogen carrier medium. A hydrogenation unit can be arranged downstream of the primary reactor.

A system for the use of hydrogen as a resource, comprising at least one reactor for producing a mixture by means of a catalytic reaction, wherein the mixture comprises hydrogen carrier medium to which hydrogen can be chemically bound by a catalytic hydrogenation reaction and from which hydrogen can be released again by a catalytic dehydrogenation reaction, and additionally hydrogen that is dissolved, i.e. physically stored, in the hydrogen carrier medium, and a hydrogenation unit that is in fluid communication with the reactor for hydrogenating the hydrogen carrier medium with the dissolved hydrogen has substantially the advantages of the method according to the invention, to which reference is hereby made.

It is particularly advantageous if the hydrogenation unit is arranged in the system in such a manner that no subsequent saturation of the hydrogen carrier medium with hydrogen gas takes place.

This can be excluded by preventing contact of the hydrogen carrier medium with hydrogen gas.

The prevention of this hydrogen gas contact is advantageous in particular because the proportion of dissolved hydrogen in the hydrogen carrier medium is reduced by means of the hydrogenation unit, in particular below the saturation limit. In particular, the proportion of dissolved hydrogen gas is lowered without new hydrogen being able to be dissolved into the liquid phase if contact with the hydrogen gas phase is prevented.

In particular, the hydrogenation unit is arranged in the system in such a manner that direct contact of the hydrogenation catalyst in the hydrogenation unit with hydrogen gas is prevented, thereby reducing the risk of gaseous hydrogen physically dissolving in the hydrogen carrier medium. This prevents renewed physical saturation of the hydrogen carrier medium with hydrogen or at least reduces the risk of hydrogen saturation.

It is particularly advantageous if the hydrogenation catalyst of the hydrogenation unit is surrounded, in particular completely surrounded, by the liquid hydrogen carrier medium.

A system configured such that the hydrogenation unit is arranged downstream of the at least one reactor, wherein in particular the hydrogenation unit is connected to the at least one reactor by means of a fluid line, in particular directly, enables an uncomplicated and advantageous retrofitting of an already existing system with a hydrogenation unit. The hydrogenation unit is connected to the at least one reactor by means of a fluid line. The connection is in particular direct if the upstream reaction is a hydrogenation reaction. In particular, if the upstream reaction is a dehydrogenation reaction, an aggregate for cooling and/or recuperation is provided between the primary dehydrogenation reactor and the hydrogenation unit. In this case, the primary dehydrogenation reactor is indirectly connected to the hydrogenation unit.

A system configured such that the hydrogenation unit is arranged in an integrated manner in the at least one reactor, in a storage container for the hydrogen carrier medium, in a tank container for the hydrogen carrier medium, in a tank vehicle for the hydrogen carrier medium and/or in an interface for providing hydrogen carrier medium can be of particularly small design. Additional installation space is not required. In particular, the hydrogenation catalyst of the hydrogenation unit is arranged directly in the reactor, in particular the primary hydrogenation reactor. It is advantageous if the hydrogenation catalyst of the hydrogenation unit is completely surrounded by the hydrogen carrier medium in the primary hydrogenation reactor. In this way, contact of the hydrogenation catalyst with the hydrogen gas phase can be excluded. The risk of gaseous hydrogen physically dissolving in the hydrogen carrier medium is reduced. The hydrogenation unit is arranged in the primary hydrogenation reactor in particular in such a manner that subsequent contact of the hydrogen carrier medium with hydrogen from the gas phase is prevented. This prevents renewed physical saturation of the hydrogen carrier medium or at least reduces the risk of physical saturation of the hydrogen carrier medium with hydrogen.

In addition or alternatively, the hydrogenation unit can also be integrated in a storage container, a tank container and/or a tank vehicle, each of which serves to store and/or transport the hydrogen carrier medium. The safety with regard to storage and transport is increased, since hydrogen that is outgassed can be chemically bound directly to the hydrogen carrier medium by post-hydrogenation. It has surprisingly been found that post-hydrogenation is already possible at temperatures in the range of ambient temperature and/or low overpressure in the presence of a hydrogenation catalyst.

Systems configured such that the at least one reactor is a primary hydrogenation reactor for hydrogenating the hydrogen carrier medium, in particular with supplied hydrogen gas, or configured such that the at least one reactor is a primary dehydrogenation reactor for dehydrogenating the hydrogen carrier medium, in particular while releasing hydrogen gas allow an advantageous post-hydrogenation of the hydrogen carrier medium.

An arrangement of the reactors in a closed loop arrangement including at least one primary hydrogenation reactor and at least one primary dehydrogenation reactor, wherein in particular one hydrogenation unit each is arranged along the flow direction of the mixture downstream of the at least one primary hydrogenation reactor and the at least one primary dehydrogenation reactor, wherein in particular the at least one primary hydrogenation reactor with the downstream hydrogenation unit are arranged at a first location and the at least one primary dehydrogenation reactor with the downstream hydrogenation unit are arranged at a second location, wherein in particular the first location and the second location are arranged at a distance from one another and in particular the first location and the second location are fluidically connected to one another, enables an advantageous closed loop process with increased use of the hydrogen as a resource.

An arrangement of the hydrogenation unit in particular upstream of a pressure regulation unit for depressurizing the mixture from the reactor, or in particular upstream of a heat exchanger for cooling the mixture from the reactor, wherein the heat exchanger is arranged in particular downstream of the pressure regulation unit, ensures an improved hydrogen yield.

Both the features indicated above and the features indicated in the embodiment examples of a system according to the invention are each suitable, alone or in combination with each other, to further embody the subject-matter according to the invention. The respective combinations of features do not constitute any restriction with regard to the further embodiments of the subject-matter of the invention, but are essentially merely exemplary in character.

Further features, advantages and details of the invention will be apparent from the following description of five embodiment examples with reference to the drawing.

### BRIEF DESCRIPTION OF THE DRAWINGS

FIG. 1 shows a schematic illustration of a system according to the invention for the use of hydrogen as a resource with a primary hydrogenation reactor,

FIG. 2 shows an illustration corresponding to FIG. 1 of a system according to a second embodiment example in which the hydrogenation unit is integrated in the primary hydrogenation reactor,

FIG. 3 shows an illustration corresponding to FIG. 1 of a system according to a third embodiment example having a primary dehydrogenation reactor,

FIG. 4 shows an illustration corresponding to FIG. 1 of a system according to a fourth embodiment example, in which various positions of the hydrogenation unit are shown,

FIG. 5 shows an illustration of a relative hydrogenation capacity related to hydrogen that is dissolved in the hydrogen carrier medium as a function of the relative amount of catalyst in the hydrogenation unit related to the amount of catalyst material in a primary hydrogenation reactor,

FIG. 6 shows an illustration of systems corresponding to FIG. 1 according to a fifth embodiment example in the form of a, in particular global, closed loop arrangement with a primary hydrogenation reactor, a primary dehydrogenation reactor and two hydrogenation units,

FIG. 7 shows a diagram to illustrate the dependence of a reactor pressure in a primary dehydrogenation reactor on time,

FIG. 8 shows a diagram to illustrate an equilibrium position between hydrogenation and dehydrogenation reaction as a function of a reactor pressure and a reactor temperature.

### DESCRIPTION OF THE PREFERRED EMBODIMENTS

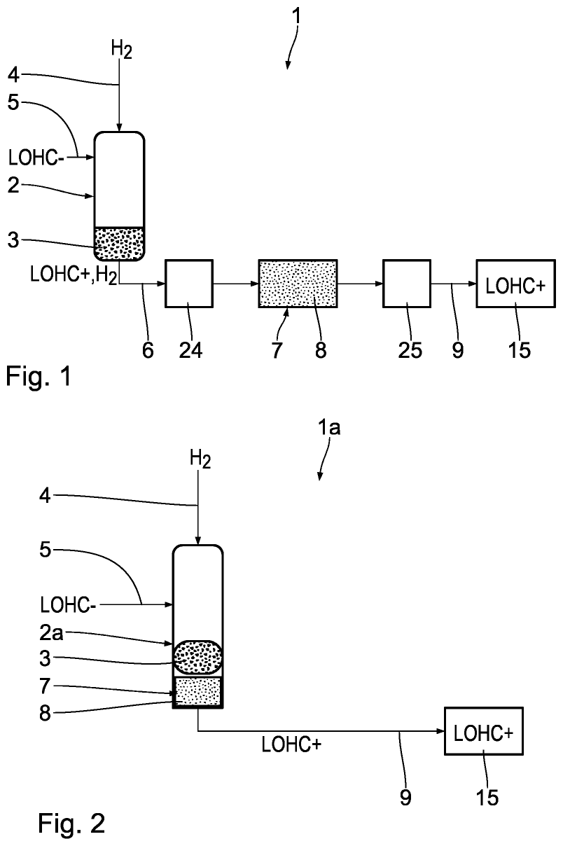

A system marked as a whole with 1 in FIG. 1 comprises a reactor 2 which, according to the embodiment example shown, is designed as a primary hydrogenation reactor. A primary hydrogenation catalyst 3 is arranged in the primary hydrogenation reactor 2, which hydrogenation catalyst 3 serves to carry out a catalytic hydrogenation reaction. A hydrogen supply line 4 for supplying hydrogen gas H₂ and a hydrogen carrier medium supply line 5 for supplying hydrogen carrier medium are connected to the primary hydrogenation reactor 2. The hydrogen carrier medium is in particular a liquid organic hydrogen carrier, which is in particular at least partially discharged (LOHC−), which is at least partially charged with hydrogen gas in the primary hydrogenation reactor:

LOHC−+H₂→LOHC+

The at least partially charged hydrogen carrier medium (LOHC+) has a degree of hydrogenation of at least 50%, in particular at least 60%, in particular at least 70%, in particular at least 80%, in particular at least 90%, in particular at least 95%, in particular at least 97% and in particular at most 99%. A hydrogenation degree of 100% means that the hydrogen carrier medium is completely charged with hydrogen gas. This theoretically complete charging does not occur in reality. If the degree of hydrogenation is less than 100%, hydrogen charging of the hydrogen carrier medium is possible. A degree of hydrogenation of 0% means that the hydrogen carrier medium is completely discharged, i.e. in particular no hydrogen is chemically bound to the hydrogen carrier medium.

A hydrogenation unit 7 is connected to the primary hydrogenation reactor 2 via a fluid line 6.

The hydrogenation unit 7 is directly connected to the primary hydrogenation reactor 2 by means of the fluid line 6. The hydrogenation unit 7 is arranged downstream of the fluid line 6 of the primary hydrogenation reactor 2. The hydrogenation unit 7 is designed as a separate unit. The hydrogenation unit 7 is arranged outside the primary hydrogenation reactor 2. A hydrogenation catalyst 8 is arranged in the hydrogenation unit 7. In particular, the hydrogenation catalyst 8 is identical to the primary hydrogenation catalyst 3.

A discharge line 9 is connected to the hydrogenation unit 7 to discharge the at least partially charged hydrogen carrier medium (LOHC+). In particular, the charged hydrogen carrier medium can be stored in a storage container 15 that is provided for this purpose.

A condenser unit 24 is arranged along the fluid line 6 between the primary hydrogenation reactor 2 and the hydrogenation unit 7. The condenser unit 24 can also be omitted. The condenser unit 24 serves to condense, in particular, vapor-like LOHC components which have been transported from the primary hydrogenation reactor 2 with the released hydrogen gas via the fluid line into the condenser unit 24. The liquefied hydrogen carrier medium with the physically stored hydrogen gas is conveyed further from the condenser unit 24 into the hydrogenation unit 7.

A separation unit 25 is arranged along the discharge line 9 between the hydrogenation unit 7 and the storage container 15. The separation unit 25 can also be omitted. The separation unit 25 serves to separate residual hydrogen gas upstream of the storage container 15. This prevents or at least minimizes the risk of residual hydrogen gas entering the storage container 15.

In the following, a method for the use of hydrogen as a resource is explained in more detail. In the primary hydrogenation reactor, the supplied, at least partially discharged hydrogen carrier medium (LOHC−) is charged with hydrogen gas (H₂) by means of a catalytic hydrogenation reaction. The hydrogen is chemically bound to the hydrogen carrier medium. The result is a charged hydrogen carrier medium (LOHC+).

In the liquid charged hydrogen carrier medium (LOHC+), hydrogen gas (H₂) is also physically stored, i.e. provided in a dissolved manner. The proportion of dissolved hydrogen gas in the charged hydrogen carrier medium (LOHC+) is about 0.05 wt. %. The mixture of the liquid charged hydrogen carrier medium (LOHC+) and the dissolved hydrogen gas is fed from the primary hydrogenation reactor 2 to the hydrogenation unit 7 via the fluid line 6. In the hydrogenation unit 7, the dissolved hydrogen is chemically bound to the charged hydrogen carrier medium (LOHC+) by means of a catalytic hydrogenation reaction. This additionally increases the degree of hydrogenation of the charged hydrogen carrier medium (LOHC+) in hydrogenation unit 7.

In the following, a second embodiment of the invention is described with reference to FIG. 2. Constructively identical parts are given the same reference signs as in the first embodiment example, the description of which is hereby referred to. Constructively different but functionally similar parts are given the same reference signs with a trailing letter a.

In the system 1a, the hydrogenation unit 7 is arranged in an integrated manner in the primary hydrogenation reactor 2a, in particular in a housing of the primary hydrogenation reactor 2a. A fluid line for connecting the primary hydrogenation reactor 2a with the hydrogenation unit 7 is dispensable.

In particular, the integrated hydrogenation unit 7 is formed exclusively by the hydrogenation catalyst 8 which is arranged in the primary hydrogenation reactor 2a. In particular, the integrated hydrogenation unit 7 does not have an independent housing. In particular, the hydrogenation catalyst 8 is completely covered by the hydrogen carrier medium. Contact of the hydrogenation catalyst 8 with the hydrogen gas phase is in particular excluded.

For example, the hydrogenation catalyst 8 is immobilized on an underside of the primary hydrogenation reactor 2a, i.e. in the sump of the primary hydrogenation reactor 2a. This means that in particular outgoing fluid lines are axially secured with a corresponding grid along the longitudinal axis of the container of the primary hydrogenation reactor 2a.

If the primary hydrogenation reactor 2a is designed as a trickle bed reactor, a lower part of the hydrogenation catalyst 8 can be flooded with hydrogen carrier medium in vertically arranged reaction tubes so that contact with the hydrogen gas phase is excluded.

It is advantageous if no contact between gaseous hydrogen and hydrogen carrier medium occurs downstream. This prevents hydrogen gas from physically dissolving again in the hydrogen carrier medium.

The method for the use of the hydrogen as a resource in the system 1a, in particular the post-hydrogenation of the hydrogen carrier medium LOHC+ with the dissolved hydrogen in the hydrogenation unit 7 corresponds to the method according to the first embodiment example, to which reference is hereby made.

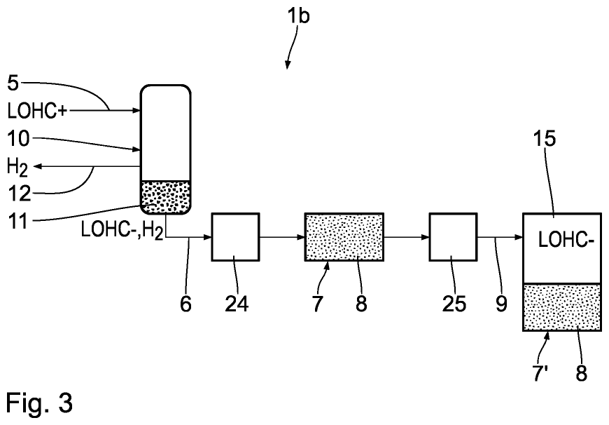

In the following, a third embodiment example of the invention is described with reference to FIG. 3. Constructively identical parts are given the same reference signs as in the first two embodiment examples, the description of which is hereby referred to. Constructively different but functionally similar parts are given the same reference signs with a trailing letter b.

In the system 1b, the reactor is designed as a primary dehydrogenation reactor 10. The hydrogen carrier medium line 5 for supplying at least partially charged hydrogen carrier medium LOHC+ is connected to the primary dehydrogenation reactor 10. A dehydrogenation catalyst 11 is arranged in the primary dehydrogenation reactor 10 for carrying out the catalytic dehydrogenation reaction. The dehydrogenation catalyst 11 has a catalyst material which comprises in particular platinum, palladium, nickel, rhodium and/or ruthenium. The catalyst material is in particular arranged on a catalyst carrier and in particular attached thereto. The catalyst carrier is in particular aluminum oxide, silicon oxide, silicon carbide and/or activated carbon.

The hydrogen gas H₂ that is released from the charged hydrogen carrier medium LOHC+ as a result of the catalytic dehydrogenation reaction can be discharged from the primary dehydrogenation reactor 10 via a hydrogen discharge line 12. Alternatively, the released hydrogen gas H₂ can be discharged together with the discharged hydrogen carrier medium LOHC− from the primary dehydrogenation reactor 10 via the hydrogen discharge line 12, wherein the initially vaporous hydrogen carrier medium LOHC− can be fed to the hydrogenation unit 7 after condensation via a connection line not shown in FIG. 3.

It is also possible to discharge the discharged hydrogen carrier medium LOHC− together with the released hydrogen gas H₂ from the primary dehydrogenation reactor 10 via the fluid line 6. The discharged hydrogen carrier medium LOHC− is present in particular in vapor form and can be cooled and/or separated together with the released hydrogen gas H₂ in the condenser unit 24, which forms a cooling/separation unit, in particular by condensation of the LOHC− vapor.

The hydrogenation unit 7 is connected to the primary dehydrogenation reactor 10 via the fluid line 6, in particular directly. It is also possible to arrange further components along the fluid line 6 between the primary dehydrogenation reactor 10 and the hydrogenation unit 7, such as condensation stages and/or recuperation stages. In this case, the primary dehydrogenation reactor 10 is indirectly connected to the hydrogenation unit 7.

In the primary dehydrogenation reactor 10, the at least partially charged hydrogen carrier medium LOHC+ is dehydrogenated by a catalytic dehydrogenation reaction:

LOHC+→LOHC−+H₂

The released hydrogen gas H₂ is discharged from the primary dehydrogenation reactor 10 via the hydrogen discharge line 12. The at least partially discharged hydrogen carrier medium (LOHC−), which is present at least partially in vapor form as a result of the dehydrogenation reaction, is fed to the hydrogenation unit 7 together with the dissolved hydrogen gas via the fluid line 6. In the hydrogenation unit 7, the at least partially dehydrogenated hydrogen carrier medium (LOHC−) is charged in a catalytic hydrogenation reaction by chemically binding the dissolved hydrogen to the hydrogen carrier medium. In the hydrogenation unit 7, cooling and a resulting condensation of the vaporous LOHC− can take place. Additionally or alternatively, this cooling and condensation can also take place in the condenser unit 24 that is located upstream of the dehydrogenation unit 7.

Alternatively, it is possible that the hydrogenation unit 7 is arranged in an integrated manner in the primary dehydrogenation reactor 10, as illustrated by the primary hydrogenation reactor in the second embodiment example.

According to the embodiment example shown, a further hydrogenation unit 7′ is arranged, in particular in an integrated manner, in the storage container 15 for the at least partially discharged hydrogen carrier medium (LOHC−). Analogous to the integrated hydrogenation unit according to the second embodiment example, the integrated hydrogenation unit 7′ is formed exclusively by the hydrogenation catalyst 8, which is arranged in particular in a bottom region of the storage container 15.

By means of the integrated hydrogenation unit 7′, hydrogen that is outgassing and/or has already outgassed from the at least partially discharged hydrogen carrier medium (LOHC−) and/or hydrogen that is still physically dissolved under ambient conditions can be chemically bound to the hydrogen carrier LOHC−.

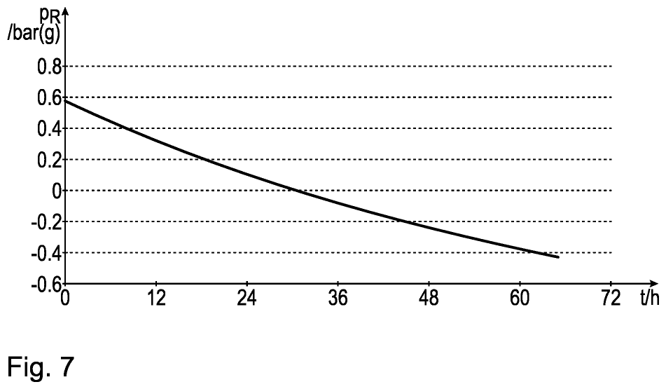

Investigations by the applicant have shown that the pressure in the primary dehydrogenation reactor 10 decreases continuously at a constant temperature at the dehydrogenation catalyst having approximately room temperature, i.e. in a temperature range of approximately 20° C. to 25° C. The pressure decrease occurs in particular over a period of several hours, in particular over several days. In particular, this time interval is at least 20 hours, in particular at least 24 hours, in particular at least 48 hours and in particular at least 60 hours. The pressure decrease leads in particular to the fact that, starting from an overpressure of at least 0.5 barg, the pressure in the reactor decreases until a negative pressure arises amounting to at least 0.2 barg, in particular at least 0.3 barg and in particular 0.4 barg. The dependence of the reactor pressure p_{R} on the time t is shown schematically in FIG. 7.

The condenser unit 24 is particularly advantageous in the embodiment example according to FIG. 3. Due to the lower pressure level of the dehydrogenation reaction and due to the reduced partial pressure of the LOHC due to the high hydrogen content, the formation of LOHC vapor is favored. By means of the condenser unit 24, the hydrogen and LOHC vapor can be reliably and efficiently separated from each other.

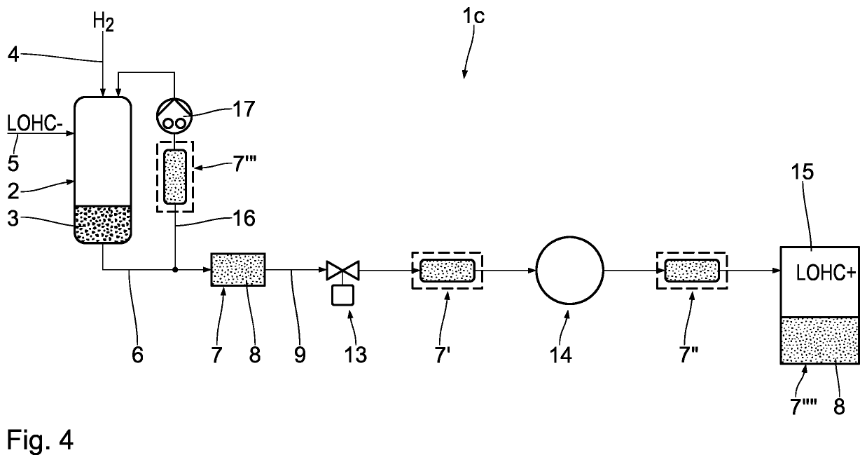

In the following, a fourth embodiment example of the invention is described with reference to FIG. 4. Constructively identical parts are given the same reference signs as in the previous embodiment examples, the description of which is hereby referred to. Constructively different but functionally similar parts are given the same reference signs with a trailing letter c.

The basic structure of the system 1c corresponds to that of the system 1 according to the first embodiment example. In addition, a pressure regulation unit 13 and a heat exchanger 14 are arranged downstream of the hydrogenation unit 7 along the discharge line 9 upstream of the storage container 15 in the system 1c.

For reasons of illustration, it is not indicated separately in each case in FIG. 4 along the fluid line 6 and along the discharge line 9 that at least partially charged hydrogen carrier medium LOHC+ and physically dissolved hydrogen H₂ are conveyed there. Nevertheless, this is the case, in particular when the hydrogen carrier medium LOHC+ and hydrogen gas have passed one of the hydrogenation units 7, 7′, 7″, 7′″ and/or 7″″, the proportion of physically dissolved hydrogen gas is reduced. The charging of the hydrogen carrier medium LOHC+ is increased.

By means of the pressure regulation unit 13, the pressure of the mixture is relieved from at least 15 barg, in particular at least 25 barg, in particular at least 30 barg, in particular at Least 40 barg and in particular at least 50 barg to at most 2.0 barg, in particular at most 1.5 barg, in particular at most 1.0 barg and in particular at most 0.5 barg.

In the heat exchanger 14 that is arranged downstream, the mixture is cooled from a temperature range between 100° C. and 300° C., in particular from 150° C. to 250° C. and in particular from at least 200° C., in particular at least 210° C., in particular at least 220° C., in particular at least 240° C. and in particular at least 260° C. to at most 80° C., in particular at most 70° C., in particular at most 60° C., in particular at most 50° C. and in particular at most 40° C. and then stocked in the storage container 15 for stocking and/or transport.

In FIG. 4, various positions are shown in dashed lines at which hydrogenation units 7, 7′, 7″, 7′″, 7″″ can be arranged in the system 1c. At each of the positions shown, a hydrogenation unit 7, 7′, 7″, 7′″, 7″″ may be arranged in addition to or as an alternative to the hydrogenation unit 7 shown in system 1c. This means in particular that the hydrogenation unit 7 shown in solid lines in FIG. 4, which is arranged along the fluid line 6 between the primary hydrogenation reactor 2 and the pressure regulation unit 13, can also be omitted.

It is essential that the respective design of the hydrogenation units 7, 7′, 7″, 7′″, 7″″ is essentially identical and in particular only their position in the system 1c varies. However, it is also conceivable that at least one or more of the hydrogenation units are designed differently, in particular contain different amounts of hydrogenation catalysts and/or different types of hydrogenation catalysts. Accordingly, the reaction conditions, in particular the reaction pressure and/or the reaction temperature for the hydrogenation units can also be different in each case, in particular depending on the position in the system 1c. The positions for the hydrogenation units are explained below.

The hydrogenation unit 7′ is arranged along the fluid flow between the pressure regulation unit 13 and the heat exchanger 14. The arrangement of the hydrogenation unit 7′ enables a comparatively efficient hydrogen yield, although the hydrogen yield is reduced compared to the arrangement of the hydrogenation unit 7 upstream of the pressure regulation unit 13.

The hydrogenation unit 7″ is arranged downstream of the heat exchanger 14, in particular between the heat exchanger 14 and the storage container 15. The arrangement of the hydrogenation unit 7″ downstream of the heat exchanger 14 prevents outgassing of dissolved hydrogen. This makes it possible to protect measuring instruments that are arranged downstream of the hydrogenation unit 7″ from gas bubble formation. Hydrogen gas bubbles that have been released before contacting the hydrogenation catalyst can be dissolved again in the hydrogen carrier medium due to the reduction of the hydrogen gas concentration in the liquid phase of the hydrogen carrier medium by the post-hydrogenation and are thus available for post-hydrogenation.

A return line 16 branches off from the fluid line 6 and is led back into the primary hydrogenation reactor 2. The hydrogenation unit 7′″ is arranged along the return line 16 and a pump 17 is arranged downstream thereof in order to return hydrogen carrier medium to the primary hydrogenation reactor 2. The arrangement of the hydrogenation unit 7′″ along the return line 16 also makes it possible to reduce the formation of gas bubbles and thus protect the pump 17.

Particularly advantageous in the system 1c is the hydrogenation unit 7 that is arranged upstream of the pressure regulation unit 13. The reaction conditions, in particular pressure and temperature, are particularly advantageous for the desired post-hydrogenation. The post-hydrogenation can be carried out particularly efficiently.

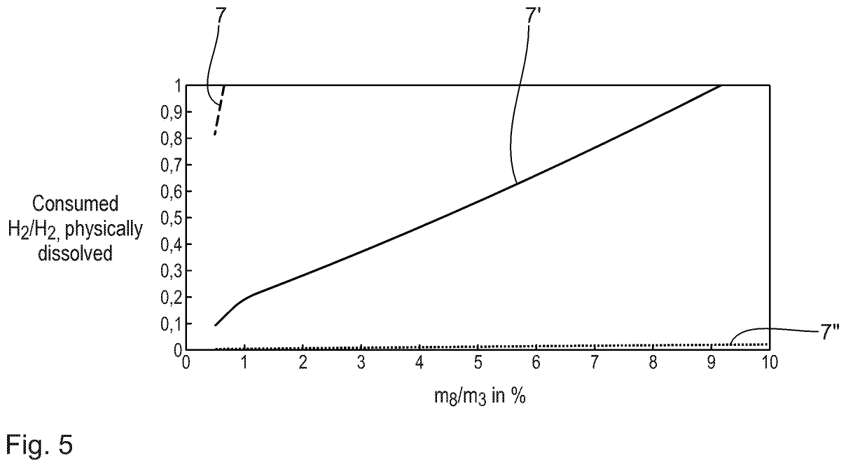

Calculation results of the applicant are shown in FIG. 5. The diagram shows the functional dependence of the relative hydrogenation capacity as a function of a relative catalyst quantity and as a function of the alternative position of the hydrogenation unit 7, 7′, 7″. The relative hydrogenation capacity describes the consumption of hydrogen in the hydrogenation unit 7 in relation to the proportion of dissolved hydrogen in the hydrogen carrier medium. A relative hydrogenation capacity of 1.0 exists when the dissolved hydrogen is completely hydrogenated in the hydrogenation unit 7, i.e. is completely chemically bound to the hydrogen carrier medium. The amount of hydrogenation catalyst 8 in hydrogenation unit 7 is given by m₈. The amount of primary hydrogenation catalyst 3 in primary hydrogenation reactor 2 is given by m₃.

As in the previous embodiment example, the hydrogenation unit 7″″ is arranged in an integrated manner in the storage container 15. The hydrogenation unit 7″″ serves to chemically bind outgassing, already outgassed and/or residual physically dissolved hydrogen to the hydrogen carrier medium LOHC+.

FIG. 5 shows that a high relative hydrogenation capacity and, in particular, a comparatively low use of the hydrogenation catalyst 8 in the primary hydrogenation reactor 2 is possible if the hydrogenation unit 7 is arranged upstream of the pressure regulation unit 13.

If the hydrogenation unit 7′ is arranged downstream of the pressure regulation unit 13, complete hydrogenation is still possible with a relative catalyst quantity of less than 10%.

As explained above, the arrangement of the hydrogenation unit 7″ downstream of the heat exchanger 14 is less relevant with regard to the relative hydrogenation capacity. Even with larger quantities of hydrogenation catalyst 8, only relatively low hydrogenation capacities are possible.

However, the arrangement of the hydrogenation unit 7″ enables an additional safeguard with respect to the logistics and/or transport of the hydrogen carrier medium, since smaller and in particular smallest quantities of hydrogen gas can still be post-hydrogenated. The risk of hydrogen gas outgassing in an uncontrolled and unintended manner is thus additionally reduced.

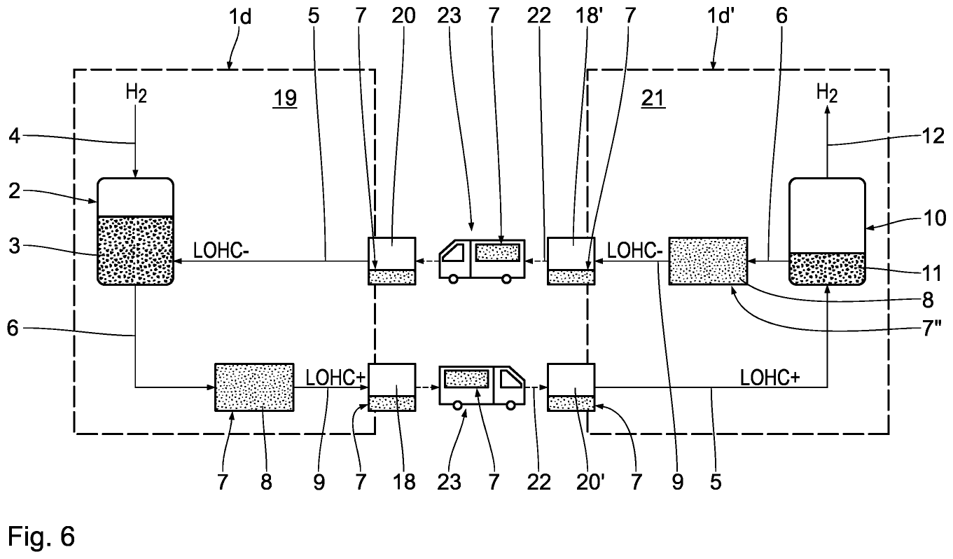

A fifth embodiment example of the invention is described below with reference to FIG. 6. Constructively identical parts are given the same reference signs as in the previous embodiment examples. Constructively different but functionally similar parts are given the same reference signs with a trailing letter d.

For ease of presentation, FIG. 6 does not separately indicate along the fluid lines 6 and/or the discharge lines 9 that physically dissolved hydrogen gas is conveyed together with the hydrogen carrier medium LOHC+, LOHC−. Nevertheless, this hydrogen gas is present in physically dissolved form in the hydrogen carrier medium LOHC+, LOHC−.

The system 1d has a primary hydrogenation reactor 2 with a downstream, first hydrogenation unit 7. The system 1d corresponds essentially to the first embodiment example according to FIG. 1, wherein a first interface 18 is arranged at the end of the discharge line 9, which interface 18 serves to provide charged, post-hydrogenated hydrogen carrier medium LOHC+. The first interface 18 serves for dispensing LOHC+ from the first location 19. The first interface 18 can also serve for, in particular temporary, storage of the LOHC+. According to the embodiment example shown, the first interface 18 has an integrated hydrogenation unit 7.

A second interface 20 is arranged at the beginning of the hydrogen carrier medium supply line 5.

Via the second interface 20, at least partially discharged hydrogen carrier medium LOHC− can be supplied at the first location 19 to the system 1d and, in particular, fed into the primary hydrogenation reactor 2 for hydrogenation. The second interface 20 can serve for at least temporary storage of the at least partially discharged hydrogen carrier medium LOHC−. According to the embodiment example shown, an integrated hydrogenation unit 7 is arranged in the second interface 20.

The system 1d is arranged at a first location 19. The first location 19 is located in particular where there is an energy surplus and in particular where hydrogen gas is to be added to hydrogen carrier medium.

Furthermore, a second system 1d′ is arranged, which has a primary dehydrogenation reactor 10 and a downstream, second hydrogenation unit 7″. The second hydrogenation unit 7″ corresponds essentially to the second hydrogenation unit 7″ according to FIG. 4 and is arranged in particular downstream of a heat exchanger not shown in FIG. 6. The second system according to 1d′ corresponds essentially to the system 1b according to the third embodiment example. The second system 1d′ is arranged at a second location 21. The second location 21 is arranged remotely from the first location 19. A spatial distance between the locations 19, 21 can be in particular several 100 meters, in particular several kilometers and in particular more than 100 or more than 1,000 kilometers. The second location 21 is arranged in particular where there is a demand for energy. For this purpose, hydrogen gas 2 can be released from the charged hydrogen carrier medium LOHC+ in the primary dehydrogenation reactor 10 and made available via the hydrogen discharge line 12.

The system 1d′ has a first interface 18′ for providing discharged, post-hydrogenated hydrogen carrier medium LOHC− for delivery from the second location 21. Furthermore, the second system 1d′ comprises a second interface 20′, via which at least partially charged hydrogen carrier medium LOHC+, in particular from the first location 19, can be supplied to the second system 1d′ and fed to the primary dehydrogenation reactor 10 via the hydrogen carrier medium supply line 5. The first interface 18′ and the second interface 20′ at the second location 21 are substantially identical in design with respect to the first interface 18 and the second interface 20 at the first location 19. In particular, one hydrogenation unit 7 each is arranged in an integrated manner in the first interface 18′ and in the second interface 20′.

It is particularly advantageous that the systems 1d and 1d′ are designed in a global closed loop arrangement and are connected to each other accordingly. In particular, the first interface 18 of the first system 1d is fluidically connected to the second interface 20′ of the second system 1d′.

The fluidic connection is symbolized in FIG. 6 by a dashed arrow 22. A fluidic connection 22 is, for example, a pipeline network which can be regional, supraregional, national and/or international. However, a fluidic connection 22 is also formed by transport vehicles such as tank trucks 23, trains and/or ships.

Accordingly, the first interface 18′ of the second system 1d′ is fluidically connected to the second interface 20 of the first system 1d.

In particular, due to the closed loop arrangement of the systems 1d, 1d′, the efficiency of the hydrogen yield is improved, in particular increased.

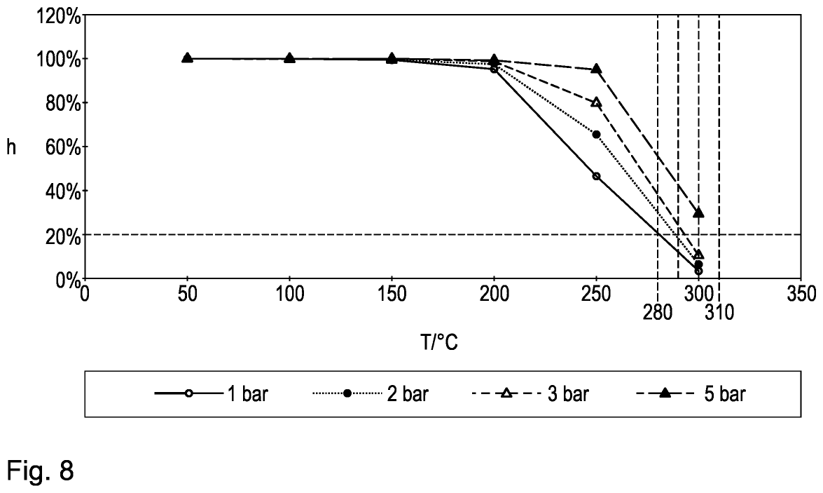

In the following, the influence of reaction pressure and reaction temperature on the chemical equilibrium between hydrogenation reaction and dehydrogenation reaction is explained with reference to FIG. 8. FIG. 8 shows a degree of hydrogenation h of 20%, which exemplarily corresponds to the degree of hydrogenation after dehydrogenation in a primary dehydrogenation reactor. The degree of hydrogenation after dehydrogenation can also be greater or less than 20%. The graphs shown in FIG. 8 correspond to different reaction pressures of 1 bar, 2 bar, 3 bar and 5 bar. The chart shows that, depending on the reaction pressure, temperatures between approximately 280° C. to 310° C. must be undershot for the equilibrium to be above the reduced degree of hydrogenation of 20% of the dehydrogenated hydrogen carrier medium, thereby enabling post-hydrogenation. In particular, it is shown that the higher the reaction pressure, the higher the maximum temperature to be undercut, i.e. approximately 310° C. at 5 bar, approximately 290° C. at 3 bar, approximately 285° C. at 2 bar and approximately 280° C. at 1 bar.

1. A method for the use of hydrogen as a resource, the method comprising the steps of
producing a mixture by means of a catalytic reaction in a reactor wherein the mixture comprises hydrogen carrier medium to which hydrogen can be chemically bound by a catalytic hydrogenation reaction and from which hydrogen can be released again by a catalytic dehydrogenation reaction, and additionally hydrogen that is dissolved, i.e. physically stored, in the hydrogen carrier medium,
hydrogenation of the hydrogen carrier medium with the dissolved hydrogen in a hydrogenation unit.

2. The method according to claim 1, wherein in that the hydrogenation in the hydrogenation unit takes place by means of a hydrogenation catalyst.

3. The method according to claim 1, wherein the hydrogenation takes place in the hydrogenation unit before the mixture from the reactor is depressurized.

4. The method according to claim 1, wherein the mixture is produced by hydrogenating the hydrogen carrier medium in a primary hydrogenation reactor that is located upstream of the hydrogenation unit.

5. The method according to claim 4, wherein the hydrogenation takes place in the hydrogenation unit before the mixture from the reactor is cooled.

6. The method according to claim 1, wherein the mixture is produced by dehydrogenating the hydrogen carrier medium in a primary dehydrogenation reactor that is located upstream of the hydrogenation unit.

7. The method according to claim 5, further comprising alternating hydrogenation and dehydrogenation of the hydrogen carrier medium in a circulation process, wherein hydrogenation of the hydrogen carrier medium with the physically dissolved hydrogen takes place in the hydrogenation unit in each case between the hydrogenation in the primary hydrogenation reactor and the dehydrogenation in the primary dehydrogenation reactor.

8. A system for the use of hydrogen as a resource, the system comprising
at least one reactor for producing a mixture by means of a catalytic reaction, wherein the mixture comprises hydrogen carrier medium to which hydrogen can be chemically bound by a catalytic hydrogenation reaction and from which hydrogen can be released again by a catalytic dehydrogenation reaction, and additionally hydrogen that is dissolved, i.e. physically stored, in the hydrogen carrier medium,
a hydrogenation unit that is in fluid communication with the reactor for hydrogenating the hydrogen carrier medium with the dissolved hydrogen.

9. The system according to claim 8, wherein the hydrogenation unit is arranged downstream of the at least one reactor.

10. The system according to claim 8, wherein the hydrogenation unit is arranged in an integrated manner at least one of in the at least one reactor, in a storage container for the hydrogen carrier medium, in a tank container for the hydrogen carrier medium, in a tank vehicle for the hydrogen carrier medium and in an interface for providing hydrogen carrier medium.

11. The system according to claim 8, wherein the at least one reactor is a primary hydrogenation reactor for hydrogenating the hydrogen carrier medium.

12. The system according to claim 8, wherein the at least one reactor is a primary dehydrogenation reactor for dehydrogenating the hydrogen carrier medium.

13. The system according to claim 11, further comprising: a closed loop arrangement including at least one primary hydrogenation reactor and at least one primary dehydrogenation reactor.

14. The system according to claim 9, further comprising a pressure regulation unit for depressurizing the mixture from the reactor.

15. The system according to claim 9, further comprising a heat exchanger for cooling the mixture from the reactor.

16. The method according to claim 3, wherein the mixture from the reactor is depressurized in a pressure regulation unit.

17. The method according to claim 5, wherein the mixture from the reactor is cooled in a heat exchanger.

18. The method according to claim 7, wherein the circulation process is global.

19. The system according to claim 9, wherein the hydrogenation unit is connected to the at least one reactor by means of a fluid line.

20. The system according to claim 9, wherein the hydrogenation unit is directly connected to the at least one reactor by means of a fluid line.

21. The system according to claim 11, wherein hydrogenating the hydrogen carrier medium is performed with supplied hydrogen gas.

22. The system according to claim 12, wherein dehydrogenating the hydrogen carrier medium is performed while releasing hydrogen gas.

23. The system according to claim 13, wherein one hydrogenation unit each is arranged along the flow direction of the mixture downstream of the at least one primary hydrogenation reactor and the at least one primary dehydrogenation reactor.

24. The system according to claim 13, wherein the at least one primary hydrogenation reactor with the downstream hydrogenation unit is arranged at a first location and the at least one primary dehydrogenation reactor with the downstream hydrogenation unit is arranged at a second location.

25. The system according to claim 24, wherein the first location and the second location are arranged at a distance from one another.

26. The system according to claim 24, wherein the first location and the second location are fluidically connected to one another.

27. The system according to claim 14, wherein the hydrogenation unit is arranged upstream of the pressure regulation unit.
